(19) United States
(12) Patent Application Publication
(10) Pub. No.: US 2015/0294278 A1
(43) Pub. Date: Oct. 15, 2015

(54) System and Method for Recycling Electronics

(71) Applicants: Tu Nguyen, Fremont, CA (US); Kevin Ta, Fremont, CA (US); Michael Smithwick, San Jose, CA (US)

(72) Inventors: Tu Nguyen, Fremont, CA (US); Kevin Ta, Fremont, CA (US); Michael Smithwick, San Jose, CA (US)

(21) Appl. No.: 14/328,661

(22) Filed: Jul. 10, 2014

Related U.S. Application Data
(60) Provisional application No. 61/979,703, filed on Apr. 15, 2014.

(51) Int. Cl. G06Q 10/00; G06Q 50/26; G06Q 20/40; G06Q 30/06

(52) U.S. Cl. CPC G06Q 10/30; G06Q 30/06; G06Q 50/26; G06Q 20/40145; G06Q 30/0609; G06Q 30/0623

(57) ABSTRACT

A kiosk for recycling electronics, comprising security features that prompt it to reject stolen or possibly stolen devices.

### CROSS-REFERENCE TO RELATED APPLICATIONS

The present application takes priority from Provisional Application No. 61/979,703, filed on Apr. 15, 2014, which is incorporated herein by reference.

### STATEMENT REGARDING FEDERALLY SPONSORED RESEARCH AND DEVELOPMENT

Not Applicable.

### BACKGROUND

1. Field of the Invention

The present invention relates generally to recycling electronic devices, and more specifically, to a system and method for recycling electronics by using a semi-automated kiosk.

2. Description of the Related Art

Due to the rapid evolution of electronic devices, consumers often have an excess of old, unwanted electronic devices cluttering up their homes. Such devices may include cell phones, PDA's, smartphones, GPS devices, calculators, mp3 players, and other similar electronics. While such devices may be worth money, it is often complicated to sell the devices, and too many of them end up thrown away. When thrown away, these devices contaminate the waste stream, due to their heavy metal content. This is a serious hazard to the environment.

While recycling facilities exist, such facilities often do not market themselves to the average consumer. Some prior art references disclose kiosks that can be placed in a location such as a supermarket and automatically evaluate a device placed within the kiosk, determine its value, and pay the consumer. However, the existing kiosks suffer from several problems. First of all, because the evaluation of the device is automatic, it is cumbersome and time-consuming—for example, U.S. App. No. 2013/004669 to Bowles et al. discloses a robotic finger inspecting the electronic device, cameras for imaging it, and a complicated method of determining the type of device and its condition. Also, due to their fully automated operation, a user is required to place their device inside the evaluation chamber and leave it there for up to 20 minutes, with the door closed and no way to get to their device if they change their mind or if the machine should malfunction.

However, the most important problem with existing kiosks is that they do not offer any ways of determining whether or not an electronic device is stolen. Smartphones are some of the most frequently stolen items, and thieves often try to resell them. While a human salesperson can often detect a thief simply by observing their behavior or by interacting with them during the transaction, a kiosk has no such capability. Even if a smartphone has theft-detection features such as Find My iPhone, a thief would simply need to render the phone nonoperational (say, by dipping it in water) and resell it at a kiosk for a low price. Even the low price such a kiosk would offer for a nonoperational smartphone would be a sufficient “return on investment” to encourage further theft. As a result, some municipalities have banned electronics-recycling kiosks, arguing that it encourages theft.

A need therefore exists for a method and system of evaluating and collecting devices for resale that detects—and rejects—stolen, or suspected to be stolen, devices up front, and that offers a simpler, cheaper way of evaluating and collecting devices.

### SUMMARY OF THE INVENTION

An object of the present invention is to enable a consumer to easily recycle, donate, trade-in, or sell their unwanted electronic devices.

Another object of the present invention is to enable easy determination of whether or not the device the consumer is trying to recycle, donate, trade-in, or sell is stolen.

Another object of the present invention is to provide a simple method of evaluating and collecting unwanted electronic devices that makes the device accessible to the consumer throughout the process of evaluation, until the device is collected and the money disbursed.

Another object of the present invention is to provide a quick method of recycling, donating, trading-in, or selling unwanted electronic devices.

In its preferred embodiment, the present invention is a system for recycling electronics, comprising a kiosk housing, a device examination area, a user interface, and a processor, where the processor is configured to communicate with an electronic device (such as a smartphone, a cell phone, an mp3 player, a mobile computer, a portable game, a camera, or the like), identify the device, determine whether or not the electronic device is likely to have been stolen, and reject the device if it is determined that the device is likely to have been stolen. If the device is determined to not be likely to have been stolen, the processor is configured to perform a functional test on the device, and in some embodiments, also to perform a cosmetic evaluation on the device, determine an appropriate compensation value for the device, and offer the compensation value to the user.

In some embodiments, the system also comprises a biometric evaluation device that captures at least some biometric information from the user. Such biometric information may be fingerprints, face images, retina scans, or the like. If the electronic device stores any biometric information in it (for example, some iPhones use fingerprints to unlock the phone), the stored biometric information can then be compared with the captured biometric information to determine whether the device is likely to have been stolen. The system can then reject the electronic device if the biometric information does not match.

In some embodiments, the processor is configured to ask the user to turn off an anti-theft feature such as “Find My iPhone” before accepting the device. If the user cannot turn off the anti-theft feature, the device is rejected by the kiosk.

In some embodiments, the processor is configured to check the device ID against a list of stolen device ID's in a law enforcement database, a phone carrier “blacklist” database, or any other database of stolen electronic devices. The system can then reject the device if the device ID is found in one such database.

If a device is rejected, the system can also take further steps to apprehend the alleged thief. For example, the system can comprise a camera that can take a photograph of a user; if the device is rejected, the system can take a photograph of the user trying to sell the device, and can send the photograph to law enforcement or to other authorities. The system can also alert the cell phone carrier associated with the device, or simply sound an alarm to summon a security officer to apprehend the user.

If the device is not rejected, the processor directs the kiosk to perform a functional test on the device. Such a functional test may test the battery, the camera, the touchscreen, the microphones, the speakers, and any other module or functionality of the device that can be tested. The tests may be performed automatically through the cable connection to the device, may be performed manually by the user, as the user follows the instructions on the kiosk's interface, or may be performed automatically by other modules within the kiosk.

The processor may also direct the kiosk to perform a cosmetic test on the device to determine its cosmetic condition. In the preferred embodiment, the kiosk prompts the user to enter the cosmetic condition of the device via the interface (for example, selecting a category from “New”, “Used”, or “Broken”), and then confirms the user's selection. The confirmation may be performed by illuminating the device with at least one LED or other light-emitting device and then determining how much light is reflected and how much light is scattered by various imperfections in the device's surface. Other methods of determining a device's cosmetic condition may also be used.

After the cosmetic and functional condition of the device are determined, the kiosk then determines an appropriate price to offer the user. The price is then displayed on the interface screen and the user is offered the option to accept or reject the offer. If the user accepts the offer, the kiosk collects the user's identification information and any other information required by law enforcement regarding secondhand dealer transactions, collects the device, and pays the user. The payment may be cash, a direct disbursement to the user's credit card or bank account, a voucher to be used in a store, or any other means of payment.

### LIST OF FIGURES

FIG. 1 shows a kiosk of the present invention.

FIG. 2 shows an interior view of the kiosk of the present invention.

FIG. 3 shows a flowchart of the operation of the kiosk of the present invention.

FIG. 4 shows an embodiment of a cosmetic scanner used in the kiosk of the present invention.

### DETAILED DESCRIPTION OF THE PREFERRED EMBODIMENT

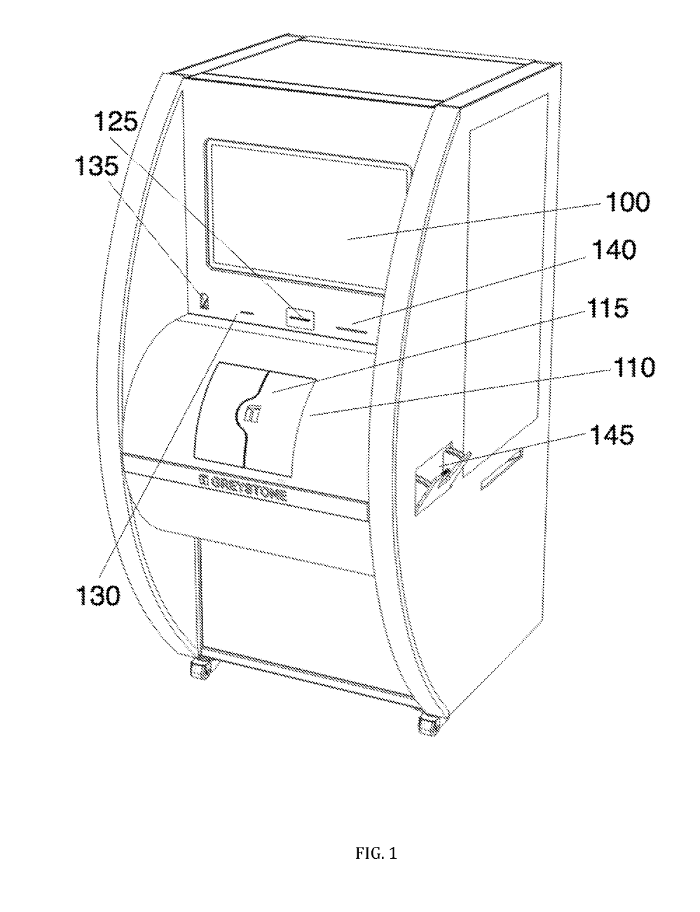

FIG. 1 shows a kiosk according to the preferred embodiment of the present invention. The kiosk is approximately the same size as a typical vending machine and is preferably located in a public place such as a shopping mall, a grocery store, a library, a gas station, or any other publicly accessible location. Touchscreen 100 serves as the user interface. In an embodiment, a speaker may also be used to play sounds or to give verbal instructions to the user. When the kiosk is not in use, the touchscreen 100 may be turned off, or may display advertisements. Inspection area 110 is where the user is expected to put the device, and comprises a set of sliding doors 115 that enclose an area big enough to accommodate the size of a typical electronic device. During the transaction, these doors are fully open and the user has the option of withdrawing the electronic device at any time, until the user accepts the offer. After the user accepts the price offer, the sliding doors close and the device is no longer accessible.

The kiosk also preferably comprises a credit card reader 125, an ID scanner 130, a fingerprint reader 135, and a printer 140 for printing receipts and labels. In an embodiment, the kiosk may also comprise a signature pad to collect the user's signature. The kiosk may also comprise any other device for collecting biometric or identification information, such as a passport scanner, a retina scanner, a DNA analyzer, a voice analyzer, a face recognition module, and so on.

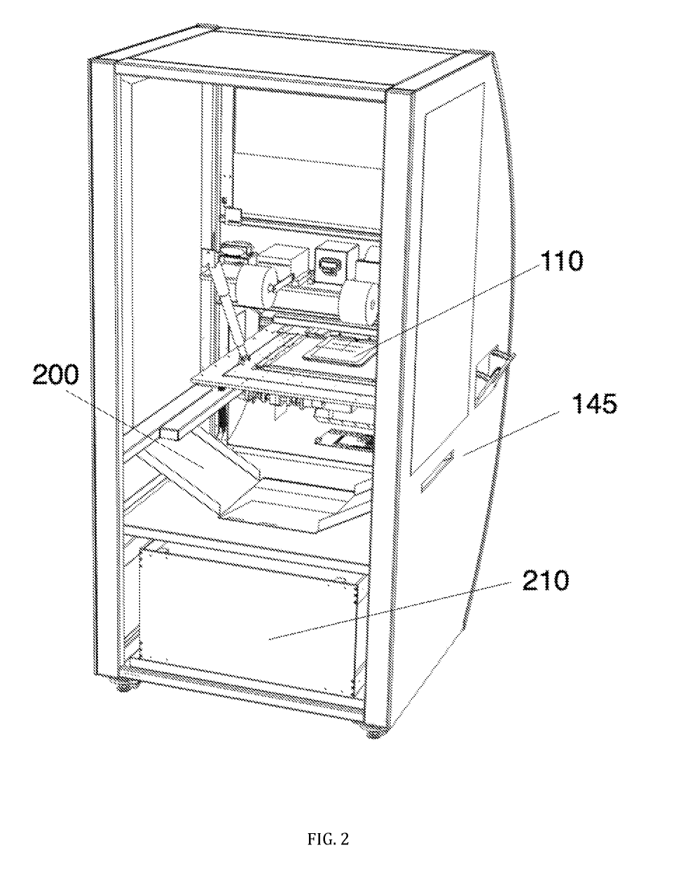

FIG. 2 shows a rear view of the kiosk according to the preferred embodiment of the present invention. It shows the inspection area 110, a chute 200, and a receptacle 210 where purchased electronic devices are stored after going through the transaction process. After an electronic device is accepted, it is directed onto the chute 200 and slides into the receptacle 210 for storage. A worker can then regularly collect the electronic devices from the receptacle as it fills up.

In an embodiment of the kiosk of the present invention, a slot 145 on the side of the kiosk is used to accept electronic devices for donation or recycling, but not for repurchase. Accepting a nonfunctional device for repurchase, however cheaply, would mean that an enterprising thief who cannot disable the theft-detection function can simply break the device and resell it at an automated kiosk. To remove any incentive for such behavior, the kiosk of the present invention does not accept nonfunctional devices for repurchase, but only for recycling or donation.

The kiosk preferably comprises a processor and a memory that is sufficient for storing and executing the instructions required for the functions described in the present application. In the preferred embodiment, the kiosk also comprises a connectivity module that is used to connect the kiosk to an online server. The connectivity module may use wired, wireless, 3G, 4G, or any other connection for that purpose.

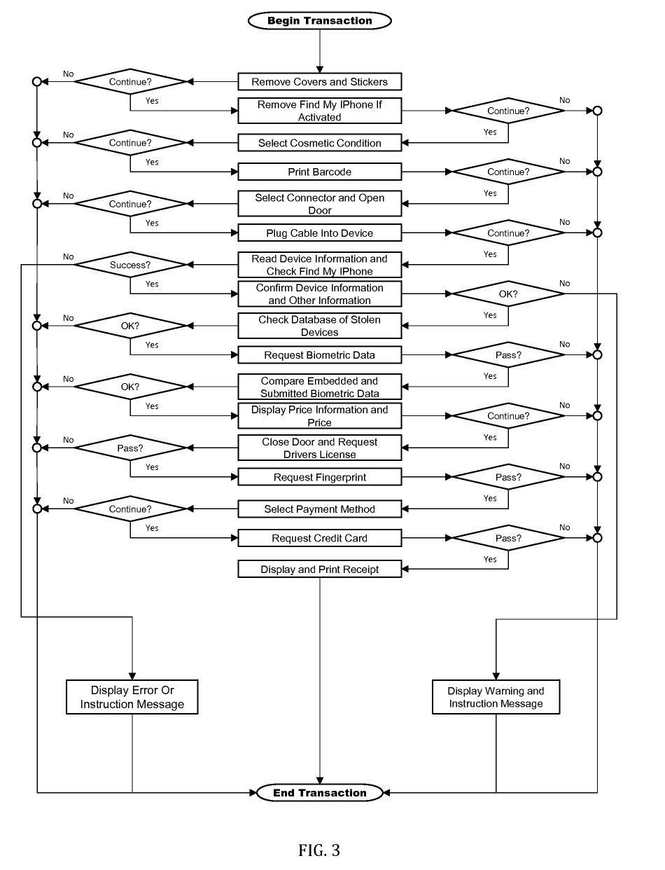

FIG. 3 shows the preferred embodiment of the method of the present invention. First, a user approaches the kiosk, which triggers the display to turn on. The display instructs the user to remove any stickers or covers from their phone and to unlock or remove any theft protection on the phone (such as FindMyIphone or similar software; note that while FIG. 3 only refers to “Find My iPhone”, the present disclosure includes any other anti-theft feature available for mobile devices).

The kiosk then prompts the user to select the condition of the device. To simplify the user's decision-making process, the kiosk preferably only offers three options—Like New, Used, and Broken—and describes to the user what each option means. In the preferred embodiment, “Like New” means there are minimal scratches or wear marks on the device; “Broken” means the screen or the body of the device is cracked or broken; and “Used” means everything in between. This affords the user a simple way of determining the condition of the device without getting into complicated details. However, the kiosk may also offer more or fewer gradations of cosmetic condition; for example, it may distinguish between “Lightly Used” and “Heavily Used”, and so on.

The kiosk then instructs the user to plug in their device using one of several available connectors provided in the inspection area. In an embodiment, the type of connector the user chooses is the first step at identifying the device; the identification is automatically narrowed down to only those devices that use that type of connector. In another embodiment, the user does not plug in their device at all, but the kiosk makes wireless contact with the device instead. In that embodiment, the first-pass identification step of using the connector is, of course, unavailable.

The kiosk then communicates with the device through the connector (or wirelessly) to determine the ID of the device, read its serial number, and determine what type of device it is. All this information is received from the device rather than from external sources. The kiosk then displays the information received from the device on the screen and asks the user to confirm the information. In an embodiment, the kiosk then checks the device ID against one or more databases containing device ID's of stolen devices. Such databases may be hosted by law enforcement, cell phone carriers, or other public or private entities. If the device ID is found in one of those databases, the kiosk rejects the device. In an embodiment, the kiosk may also take additional steps of taking a picture of the user, alerting law enforcement, or alerting store personnel by sounding an alarm once the device is rejected.

In an embodiment, the user enters the device type and condition on a website prior to going to the kiosk to determine an appropriate price for the device. The website then generates an ID, bar code, or label for the user to print out or enter prior to going to the kiosk. The kiosk then verifies the type and condition of the device, and if they match what the user originally entered and if the device is not suspected to be stolen, the kiosk honors the price given by the website.

In an embodiment, the kiosk also checks the device ID in databases that store ID's of stolen devices. Such databases may include law enforcement databases, phone carrier “blacklist” databases, or privately owned databases. In such an embodiment, the device will be rejected if its device ID is found in such a database. The kiosk may also perform additional steps if a device ID is found to be in such a database, such as alerting law enforcement, taking a picture or video of the person attempting to sell the device, alerting the phone company, and so on.

The kiosk also communicates with the device to determine whether an anti-theft function such as “Find My iPhone” (or any similar anti-theft function available for electronic devices) is turned on. While this cannot be ascertained directly for the iPhone, it may be done indirectly as follows. The kiosk may ask the device for information normally blocked by anti-theft technology; if the device does not provide the information, it means that Find My iPhone is turned on. Alternately, the kiosk may provide the device ID to the Apple website and report a problem with the device; the response received from the Apple website may include a request to disable Find My IPhone prior to service. The existence or absence of such a request may be interpreted to determine whether or not Find My iPhone is turned on.

If the anti-theft protection is turned on, the kiosk prompts the user to turn it off. If the user cannot turn it off, the kiosk rejects the device and optionally also sounds an alarm to alert store personnel, alerts law enforcement, takes a picture or video of the person attempting to sell the device, alerts the phone company, and so on. In an alternate embodiment, the kiosk simply rejects the device and takes no further steps.

In an embodiment, the kiosk also accesses stored fingerprint or other biometric information in a device that uses biometrics to control access, such as the iPhone 5. The kiosk then prompts the user to enter their own biometric information into the kiosk (for example, by means of a fingerprint reader or a retina scanner). If the biometric information received from the device does not match the biometric information received by the kiosk, the device is rejected. As before, the kiosk may also sound an alarm to alert store personnel, alert law enforcement, take a picture or video of the user, alert the phone company, and so on. In an alternate embodiment, the kiosk communicates its location to law enforcement along with any other pertinent information; law enforcement personnel can then be aware of the location of the potential thief at that moment in time.

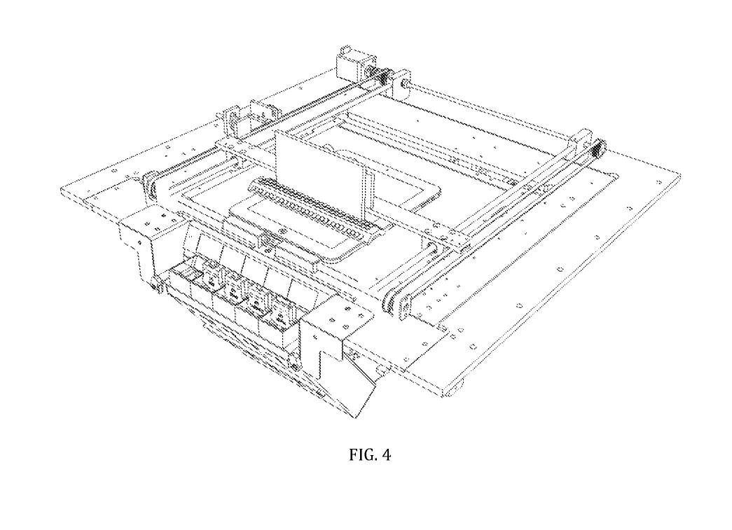

If the device is not rejected at that point, the kiosk then confirms the user's claims regarding the device's condition. In the preferred embodiment, the kiosk quickly examines the device using an array of light emitters and light sensors as shown in FIG. 4. The light sensors are positioned in such a way as to measure light reflected off the device's screen and light scattered by the device's screen. If the amounts of reflected light are relatively consistent throughout the device's surface, the device is classified as “Like New”; if the amounts of reflected and scattered light are very inconsistent, the device is classified as “Broken”; and anything in between is classified as “Used”. Other types of gradations may also be set.

A nonfunctional broken device will not be accepted by the kiosk, because the kiosk will be unable to communicate with the device. Repurchasing devices that are nonfunctional would encourage thieves to render stolen devices nonfunctional in order to resell them; thus, the kiosk of the present invention only accepts working devices. In an embodiment, the kiosk has a slot on the side to accept nonfunctional devices at no cost for recycling.

In the preferred embodiment, after confirming the user's claims regarding the device's condition, the kiosk prints out a barcode sticker to stick on the device, including a tracking number, to enable the device to be properly identified as it goes through the recycling process. The user is then prompted to stick the barcode sticker on the device.

After the device and the device's condition are verified, the kiosk offers a price to the user (assuming the user wishes to sell rather than donate the device). The price may be determined by a database stored in the kiosk itself, a database stored on the Internet to which the kiosk connects remotely, a formula or calculator stored in the kiosk or on the Internet, or by any other valuation methods known in the art. In an embodiment, the price may be determined by a human salesperson. After the user accepts the offer, the device is rendered inaccessible to the user (by closing the sliding doors 115, or by any other method).

The user is then prompted to perform an identification step. Such an identification step may involve scanning in the user's driver's license or other ID, scanning the user's fingerprint or retina, photographing and identifying the user's face, or any other form of identification. The identification is then stored in the kiosk's memory, in a database located on the Internet, on a cloud server, or in any other location, and associated with the device. In an embodiment, the photo on the ID may be compared with the user's face to make sure the user really is the person they say they are. The kiosk may also collect the user's signature and compare it to the signature on the user's driver's license or credit card.

In an embodiment, the kiosk may also automatically report the transaction to any government agency as required by law for secondhand dealers. It may automatically generate a form for the customer to sign, automatically report the transaction to any online service used by the government, or perform any other steps required by law to report the transaction.

Finally, the user is prompted to accept payment. Payment may be dispensed by transferring funds to the user's credit card or bank account, automatically dispensing a ticket that can be redeemed for cash, web-based payment services, near-field communications with the user's mobile device, or other means of dispensing payment known in the art. The device is drawn into a receptacle located within the kiosk, and sent to a recycling facility, a resale facility, or any other destination. The kiosk can also display and print the receipt for the transaction.

While exemplary embodiments have been described above, those skilled in the art will readily realize that numerous changes, modifications, and substitutions may be made without departing from the spirit and scope of this invention, which is limited only by the appended claims.

1. A system for recycling electronics, comprising:
a kiosk housing;
a device examination area;
a user interface;
a processor;
wherein the processor is configured to communicate with an electronic device placed in the device examination area, said electronic device selected from a group comprising smartphones, cell phones, mp3 players, mobile computers, portable games;
wherein the processor is configured to identify the brand, model, and serial number of the electronic device;
wherein the processor is configured to determine whether the electronic device rightfully belongs to a user;
wherein the processor is configured to reject the electronic device if it cannot be determined that it rightfully belongs to the user;
wherein the processor performs a functional test on the electronic device;
wherein the processor is configured to determine an appropriate compensation value for the device solely based on the information received from the electronic device and from the user and offer the compensation value to the user.

2. The system of claim 1, further comprising a cosmetic evaluation device, wherein the cosmetic evaluation device performs a cosmetic evaluation on the electronic device.

3. The system of claim 2, wherein the cosmetic evaluation device comprises:
at least one light emitting device that emits electromagnetic radiation on at least one wavelength onto a surface of the electronic device;
at least one first light sensor that is positioned in a way that senses electromagnetic radiation reflected off the surface of the electronic device;
at least one second light sensor that is positioned in a way that senses electromagnetic radiation scattered by the surface of the electronic device.

4. The system of claim 3, wherein the cosmetic evaluation device is moved in such a way as to emit electromagnetic radiation onto the entire surface of the electronic device, wherein the processor is configured to evaluate a first percentage of the electromagnetic radiation sensed by the first light sensor and a second percentage of the electromagnetic radiation sensed by the second light sensor at a first area of the device, and to evaluate a third percentage of the electromagnetic radiation sensed by the first light sensor and a fourth percentage of the electromagnetic radiation sensed by the second light sensor at a second area of the device, to compare the first percentage with the third percentage, to compare the second percentage with the fourth percentage, and to use the comparisons to evaluate the smoothness of the surface of the device.

5. The system of claim 1, further comprising a biometric evaluation device, wherein the biometric evaluation device captures at least one item of biometric information from the user.

6. The system of claim 3, wherein the electronic device stores at least one stored item of biometric information, wherein the processor is configured to compare the stored item of biometric information with the item of biometric information captured by the biometric evaluation device and to reject the electronic device if the stored item of biometric information does not match the item of biometric information captured by the biometric evaluation device.

7. The system of claim 4, wherein the stored item of biometric information and the item of biometric information captured by the biometric evaluation device are fingerprints.

8. The system of claim 4, wherein the stored item of biometric information and the item of biometric information captured by the biometric evaluation device are face images.

9. The system of claim 4, wherein the stored item of biometric information and the item of biometric information captured by the biometric evaluation device are retina images.

10. The system of claim 4, wherein the stored item of biometric information and the item of biometric information captured by the biometric evaluation device are voice prints.

11. The system of claim 1, wherein the processor determines whether the electronic device belongs to a user by asking the user to turn off an antitheft feature.

12. The system of claim 1, wherein the processor determines whether the electronic device belongs to a user by:
communicating with the device and asking it to provide information normally blocked by antitheft features;
if the device does not provide the information, asking the user to turn off an antitheft feature;
if the user cannot turn off the antitheft feature, determining that the electronic device does not belong to the user.

13. The system of claim 1, wherein the processor communicates with law enforcement if it cannot be determined that the electronic device belongs to the user.

14. The system of claim 1, further comprising a camera, wherein the system takes a photograph of the user if it cannot be determined that the electronic device belongs to the user.

15. The system of claim 1, wherein the processor determines whether the electronic device belongs to a user by checking for its device ID in at least one of law enforcement database, phone carrier “blacklist” database, or privately owned database of stolen electronic devices.

16. A method of recycling electronics, comprising:
receiving an electronic device from a user, said electronic device selected from a group comprising smartphones, cell phones, mp3 players, mobile computers, portable games;
communicating with the electronic device;
determining the brand, model, and serial number of the electronic device;
determining whether the electronic device belongs to the user;
rejecting the electronic device if it is determined that the electronic device does not belong to the user;
performing a functional evaluation of the electronic device if it is determined that the electronic device belongs to the user;
performing a cosmetic evaluation of the electronic device if it is determined that the electronic device belongs to the user;
determining a compensation value for the electronic device based on the identification of the electronic device, the functional evaluation, and the cosmetic evaluation;
offering the compensation value to the user.

17. The method of claim 16, where determining whether the electronic device belongs to a user comprises:
asking the user to turn off a theft-detection feature.

18. The method of claim 16, where determining whether the electronic device belongs to a user comprises:
capturing an item of biometric information from the user;
comparing the item of biometric information with a stored item of biometric information stored in the electronic device.

19. The method of claim 18, where the item of biometric information is a fingerprint.

20. The method of claim 18, where the item of biometric information is a facial image.

21. The method of claim 18, where the item of biometric information is a retina image.

22. The method of claim 16, where determining whether the electronic device belongs to a user comprises:
determining a device ID of the electronic device;
searching for the device ID in a database of stolen electronic devices.

23. The method of claim 16, further comprising:
taking a photograph of the user if it is determined that the electronic device does not belong to the user;
sending the photograph to law enforcement.

24. The method of claim 16, further comprising:
alerting a cell phone carrier if it is determined that the electronic device does not belong to the user.

25. The method of claim 16, further comprising:
sounding an alarm if it is determined that the electronic device does not belong to the user.
